(19) United States
(12) Patent Application Publication
(10) Pub. No.: US 2009/0232579 A1
(43) Pub. Date: Sep. 17, 2009

(54) LIPSTICK WITH MULTIPLE FUNCTIONS

(75) Inventors: Peter Obereisenbuchner, PeiBenberg (DE); Thomas Weckerle, Oberhausen (DE)

Correspondence Address: HOWARD & HOWARD ATTORNEYS PLLC, 450 West Fourth Street, Royal Oak, MI, 48067, US

(73) Assignee: Weckerle GmbH, Weileim (DE)

(21) Appl. No.: 12/402,594

(22) Filed: Mar. 12, 2009

(30) Foreign Application Priority Data
Mar. 12, 2008 (EP) 08 004 558.6

(51) Int. Cl. B43K 27/04; B65D 85/72; B43K 23/00

(52) U.S. Cl. 401/17; 401/19; 206/385; 401/55; 401/98

(57) ABSTRACT

Apparatus (1, 21) for selectively applying two components, having: a case (2, 22); a first body (3, 23) from a first component for applying, wherein said first body (3, 23) is arranged at least partially in said case (2, 22); a second body (4, 24), wherein said second body (4, 24) is arranged at least partially in said first body (3, 23) and means (5, 25) to transport said first body (3, 23) independently of said second body (4, 24) at least partially out of said case (2, 22) and into said case (2, 22).

### RELATED APPLICATIONS

This application claims priority to European Patent Application Number 08004558.6, filed Mar. 12, 2008.

### FIELD OF THE INVENTION

The present invention is directed to a novel apparatus for selectively applying two components, in particular a lipstick with which the user may selectively apply one of at least two components to the lips.

### BACKGROUND OF THE INVENTION

Lipsticks basically contain one component. In a known embodiment of a lipstick the lipstick lead is made of this component. By moving the lipstick lead along a lip, this component is dispersed on the lip.

Moreover, many further apparatuses for applying other components to a lip are known. One example is the so called lip liner. This lip liner basically consists of a single component as well, the so called lip liner. This lip liner normally contains less water and lipids than a lipstick lead and in general has a more solid consistency. Lip liners are mostly used to border the lip and prevent a blending or smearing of the applied lipstick. Lip liners are often arranged in a sleeve of wood, plastic or metal.

Usually a user fist uses the lipstick and subsequently traces the lip contour with the lip liner.

Further examples of components for applying to the lips are moisturizers and sunscreens.

For the care of the lips the user not only has to carry several items but has to handle the items one after another.

Thus, there is basically a need for an apparatus, which simplifies the handling of a lipstick and other apparatuses for applying to the lips. Therefore, the present invention has the objective to provide such an apparatus.

### SUMMARY OF THE INVENTION

According to the invention this objective is solved by an apparatus according to independent claim 1. Advantageous embodiments result from the dependent claims.

The apparatus according to the invention for selectively applying two components has a case, a first body and a second body. According to the invention, the first body is arranged at least partially in the case. This first body consists of a first component for applying, i.e. the user may apply this first component for example to a lip. According to the invention, the second body is arranged at least partially in the first body. According to the invention, the apparatus furthermore has means to transport the first body independently of the second body at least partially out of the case and into the case. If the first body has been transported out of the case by the means, the first body is accessible and the user may apply the first component. If the body has been transported into the case by the means, the second body is accessible. This is in particular helpful if the user can apply a second component by means of the second body.

The apparatus according to the invention provides the user for the first time with an apparatus, which allows for a simple handling when applying two components for example a lipstick and a lip liner. In particular the user now has to carry only a single item to selectively apply two components. Moreover, the handling is essentially simplified since the user may selectively apply the one or the other component by transporting the first body out of the case and into the case without putting down the apparatus or without turning the apparatus. The invention furthermore allows for a compact construction to provide an apparatus for selectively applying two components, since the second body is arranged at least partially in the first body.

According to a preferred embodiment of the present invention the means to transport the first body independently of the second body at least partially out of the case and into the case has a rotary mechanism. Preferably the rotary mechanism has a thread at the inner surface of the case. By means of this rotary mechanism the transport of the first body may be realized in a simple way and without components wasting space and without complicated components.

Preferably the first body is arranged in a basket. In a preferred embodiment this basket is moved back and forth by means of a thread at the inner surface of the case to transport the first body out of the case or into the case as desired.

In a preferred embodiment the first body is a lipstick lead.

In a further preferred embodiment the means also transports the second body independently of the first body at least partially out of the case and into the case. Thereby the handling is further simplified for the user. For example with the aid of such a means the second body may further be moved out of the case and also out of the first body.

In an embodiment also the second body consists of a component for applying, the so called second component. For applying, the second body may be moved out of the case and out of the first body with the aid of the means, such that the second component may for example be a applied to a lip without obstruction by the first body or the case. To this end the means advantageously has a spindle. This spindle may be in connection with a portion of the case and may thus allow the user, for example by rotating this portion of the case, to move the second body back and forth as desired. Advantageously the second body is arranged in a basket, which carries the body and allows for transport of the body. According to a preferred embodiment of the invention the second body is a lip liner.

In an alternative preferred embodiment of the invention the second body does not consist of a second component for applying but has an opening through which the second component for applying can be transported. In this case, the second component is preferably designed such that it may be transported for applying. Preferably it is then a liquid component. In a preferred embodiment the case has a storage for the second component, which is in connection with the opening in the second body such that the second component can be transported from the storage to the body.

To allow for the transport of the second component selectively, i.e. according to requirements or desire of the user, from the storage to the opening in the body, the apparatus preferably has an adapted means. In a preferred embodiment the means is at least a deformable wall of the storage. By means of the deformable wall, like for example the wall of a tube, the second component may be transported to the opening of the body by pressing of the user. The user can influence the amount of the transported component by different pressure.

According to a preferred embodiment of the present invention the apparatus according to the invention also has a cap. By means of the cap the apparatus, and in particular the first body and the second body is protected when the apparatus is not in use. Preferably the cap has a nose, which is arranged at least partially in the opening of the second body if the cap is closed. This nose assures that parts of the first or second component do not clog the opening of the second body. Furthermore, an accidental leakage of the second component, for example during the transport of the apparatus, is avoided.

The apparatus according to the invention preferably is a lipstick in which a lip liner is integrated.

Further advantages and features of the invention can be extracted from the following detailed description, in which the invention is described in more detail and with respect to the exemplary embodiments depicted in the enclosed figures.

### BRIEF DESCRIPTION OF THE DRAWINGS

FIG. 1 shows a cross section of an embodiment of the present invention with two bodies of components for applying; and

FIG. 2 shows a cross section of an alternative embodiment of the present invention in which one body has an opening through which a component for applying can be transported.

### DETAILED DESCRIPTION OF THE PREFERRED EMBODIMENT

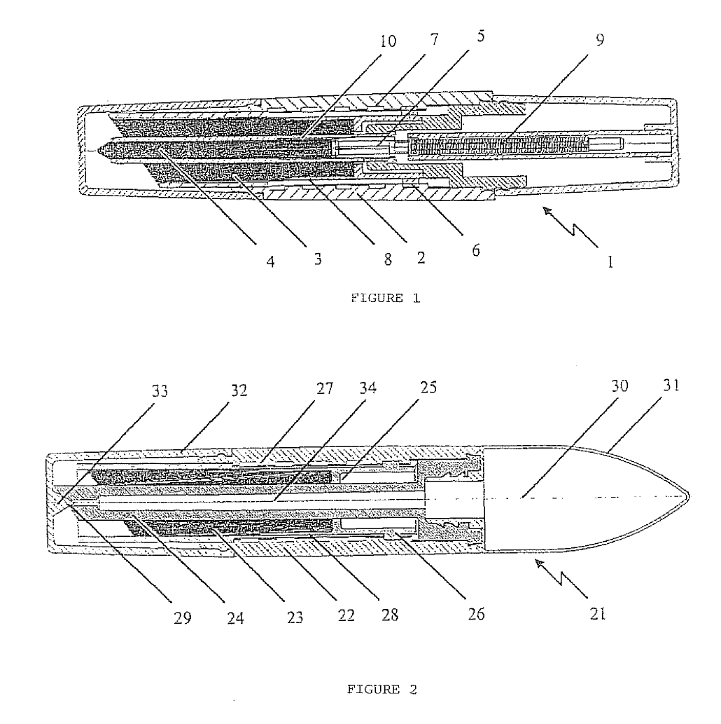

FIG. 1 exemplarily shows the present invention by means of an embodiment of an apparatus 1 with a lipstick and a lip liner. The apparatus 1 has a case 2, which may for example consist of plastics or metal. In the depicted embodiment the case 2 has a cylindrical form. Different forms, for example with oval or rectangular cross section are conceivable as well.

The apparatus 1 contains as first body 3 a lipstick lead. The lipstick lead 3 is arranged at least partially in the case 2. For demonstration an embodiment is shown in which the lipstick lead 3 is slant at its front side, i.e. the side, which contacts the lips when using the lipstick. Basically it is possible that the lipstick lead 3 has a different form. The lipstick lead 3 consists of a first component. This first component consists of a material or a composition of materials, which is adapted and designed to be applied to a lip. The lipstick lead 3 preferably has a circular cross section and preferably has a diameter in the magnitude of 7 to 35 mm. Basically the forms and proportions of the lipstick lead 3 or the first body, respectively, may be freely chosen depending on the usage of the apparatus according to the invention and depending on the used components. In the depicted exemplary embodiment the lipstick lead 3 is arranged in a basket 8 by means of which the lipstick lead can be transported back and forth.

In the embodiment depicted in FIG. 1 the apparatus 1 has a lip liner 4 as second body 4. For demonstration an exemplary embodiment is shown, in which the lip liner 4 or the second body 4, respectively, is tapered at the front side, i.e. the side, which contacts the lips when using the lip liner. By this feature a precise contouring of the lips is possible. Basically it is possible that the lip liner 4 has a different form.

The second body 4 may basically be realized also by means of different components. Second components made of materials or material compositions, which are adapted and designed to be applied to a lip may for example be considered.

Furthermore, the exemplary embodiment shown in FIG. 1 has a means 5 to transport the lipstick lead 3 or the first body 3, respectively, independently of the lip liner 4 or the second body 4, respectively, at least partially out of the case 2 or into the case 2. The means has a rotary mechanism 6 to allow for the transport of the lipstick lead 3. Basically, however, the skilled person knows that also a different mechanism like for example a moving mechanism is possible. In the depicted exemplary embodiment the rotary mechanism 6 is realized by means of a thread 7 at the inner surface of the case 2. The basket 8 in which the lipstick lead 3 is arranged has an adapted nose, which engages in the thread 7.

In the embodiment of the apparatus 1 depicted in FIG. 1 also the second body 4 can be transported by means of the means 5 independently of the first body 3 at least partially out of the case 2 or into the case 2. To this end the second body 4 is arranged in a basket 10, which can be moved by means of a spindle 9.

FIG. 2 depicts an alternative exemplary embodiment of the apparatus 21 according to the invention. Like the exemplary embodiment depicted in FIG. 1, the lipstick 21 has a case 22 and a first body 23 or lipstick lead 23, respectively, from a first component for applying. The lipstick lead is arranged at least partially in the case 22 as well. Furthermore, the depicted exemplary embodiment has a second body 24, which is arranged at least partially in the lipstick lead 23 and a means 25 to transport the lipstick lead 23 independently of the second body at least partially out of the case 22 and into the case 22.

Everything said in the context of the exemplary embodiment depicted in FIG. 1 about the case, the lipstick lead, and the means is analogously true for the alternative exemplary embodiment depicted in FIG. 2. In contrast to FIG. 1, FIG. 2 shows an exemplary embodiment with a second body 24 with an opening 29 through which a second component for applying can be transported. Therefore, the second body 24 may consist of different materials like for example plastics or metal. In the depicted exemplary embodiment the second body 24 has a cylinder form. An oval or rectangular cross section is conceivable as well. The second body 24 is slant at the front side, which contacts the lips when used, to simplify the application of the second component. Other forms of the front side like for example a circular form are possible as well.

The lipstick 21 has also a storage 30 in which the second component may be stored. Preferably the storage 30 is in connection with the opening 29. In the exemplary embodiment depicted in FIG. 2 the connection is realized by a channel 34, which is formed by a cylindrical recess or bore in the second body 24. However, the skilled person knows that different means for the transportation of the second component like for example hoses are appropriate as well. Furthermore, the storage 30 has a means 31 like for example a deformable wall, with which the user of the lipstick 21 may selectively cause a transport of the second component from the storage 30 to the opening 29 in the second body 24.

Depending inter alia on the consistency of the second component, different storages and different means for transporting the second component from the storage 30 to the opening 29 are conceivable. In the exemplary embodiment depicted here a liquid second component is assumed and a storage, which has the form of a tube. The tube 30 has the advantage that it has a deformable wall 31, such that pressing the wall 31 moves the second component in the direction of the opening 29 of the second body 24. Depending on the pressure exercised on the tube the user of the apparatus 21 according to the invention may select the amount of the second component to be applied to the lip.

The size of the opening 29 in the second body 24 basically depends on the second component used. When choosing the component, attention should be paid however that the opening 29 in the second body 24 does not clog such that the operability of the lipstick 21 according to the invention is guaranteed.

The exemplary embodiment depicted in FIG. 2 of the lipstick 21 according to the invention furthermore has a cap 32. Just like the case 22 this cap may be made of different materials. Examples are plastics or metal. The cap 32 has a nose 33, which is arranged at least partially in the opening 29 of the second body 24 if the cap is closed. The nose 33 has the form of a cone in the depicted exemplary embodiment. Basically however different 20 forms, for example a cylinder, are conceivable. When closing the cap 32, the nose 33 is inserted at least partially into the second body 24. Thereby, a removal of residues of the second component may be achieved. Furthermore, the nose 33 seals the opening 29 such that an accidental leakage of the second component, for example during the transport of the lipstick 21, is avoided.

Thus, an apparatus is provided by the present invention for the first time, which simplifies the handling of a lipstick and other apparatuses for applying to the lips.

1. Apparatus for selectively applying two components, having:
a case;
a first body from a first component for applying, wherein said first body is arranged at least partially in said case;
a second body, wherein said second body is arranged at least partially in said first body and
means to transport said first body independently of said second body at least partially out of said case and into said case.

2. Apparatus according to claim 1, wherein said means has a rotary mechanism.

3. Apparatus according to claim 2, wherein said rotary mechanism has a thread at the inner surface of said case.

4. Apparatus according to claim 1, wherein said first body is arranged in a basket.

5. Apparatus according to claim 1, wherein said first body is a lipstick lead.

6. Apparatus according to claim 1, wherein said means also transports said second body independently of said first body at least partially out of said case and into said case.

7. Apparatus according to claim 6, wherein said means has a spindle.

8. Apparatus according to claim 1, wherein said second body consists of a second component for applying.

9. Apparatus according to claim 8, wherein said second body is arranged in a basket.

10. Apparatus according to claim 8, wherein said second body is a lip liner.

11. Apparatus according to claim 1, wherein said second body has an opening, through which said second component for applying can be transported.

12. Apparatus according to claim 11, wherein said case has a storage for said second component, wherein said storage is in connection with said opening in said second body.

13. Apparatus according to claim 12, wherein said storage has means, with which the user of the apparatus may selectively cause a transport of said second component from said storage to said opening in said second body.

14. Apparatus according to claim 13, wherein said means is at least a deformable wall of said storage.

15. Apparatus according to claim 11, wherein said apparatus has a cap, wherein said cap has a nose, which is arranged at least partially in said opening of said second body if said cap is closed.
